(19) United States
(12) Patent Application Publication
(10) Pub. No.: US 2022/0219464 A1
(43) Pub. Date: Jul. 14, 2022

(54) METHOD AND SYSTEM FOR MARKING PAPER, CARDBOARD AND/OR FABRIC

(71) Applicant: MACSA ID, S.A., SANT FRUITOS DE BAGES (BARCELONA) (ES)

(72) Inventors: SVEN ALEXANDER VOGLER, SANT FRUITOS DE BAGES (BARCELONA) (ES); FRANCISCO BRAVO MONTERO, SANT FRUITOS DE BAGES (BARCELONA) (ES); JAUME ALMIRALL MATAS, SANT FRUITOS DE BAGES (BARCELONA) (ES); CARLES GANNAU VILANOVA, SANT FRUITOS DE BAGES (BARCELONA) (ES)

(21) Appl. No.: 17/596,348

(22) PCT Filed: Jun. 17, 2020
(86) PCT No.: PCT/ES2020/070392

§ 371 Date: Dec. 8, 2021

(30) Foreign Application Priority Data
Aug. 2, 2019 (EP) 19382678.1

(51) Int. Cl. B41J 2/475; B41J 2/44; B41M 5/00; B41M 5/26

(52) U.S. Cl. CPC B41J 2/4753; B41M 5/26; B41M 5/0011; B41J 2/442

(57) ABSTRACT

A method for marking at least one portion of a surface of an object, said surface being made of a material that is paper, cardboard or fabric, the method comprising the following steps:
heating the surface of the material by means of a heat source to a temperature lower than a temperature at which the visual appearance of the material changes;
marking the heated surface by means of a marking laser, so that the light beam of the laser raises the temperature on the surface of the material enough to change the visual appearance of said surface;

in which the marking laser is a laser with a light beam that belongs to the visible or ultraviolet spectrum.

The present application relates to a method for marking objects made of paper, cardboard and/or fabric, and to a system for marking paper, cardboard and/or fabric.

Methods and systems for marking paper, cardboard and/or fabric which do not require the use of conventional ink are known. These ink-free marking methods are also referred to as printing methods. Systems for marking or printing objects made of paper, cardboard and/or fabric without ink, using lasers, are also known. In these cases, the laser heats the surface of the material to its carbonisation temperature, following which the substrate changes colour, obtaining a marking similar to that made with ink. For this purpose, an infrared laser is generally used, since this is the most efficient type of laser for heating.

One problem with the prior art is that marking/printing by infrared laser creates by-products derived from the carbonisation of the printed material, such as char and/or tar compounds, thus requiring additional steps in order to fix such by-products.

Dutch patent document NL2017141 discloses a printing apparatus that comprises a laser for treating a material or substrate, which in this document is paper. In said apparatus, the printing is carried out by means of an infrared laser that heats the substrate to its carbonisation temperature, changing the colour of the substrate and obtaining the printing or marking effect. This printing comprises a prior step of pre-heating the substrate, in which the substrate is heated to below the carbonisation temperature in order to ensure that the printing speed is faster since the substrate has a higher initial temperature. This process creates some by-products that must be treated by a post-treatment. Said post-treatment includes fixing the by-products by an electromagnetic radiator that can comprise an ultraviolet source and/or an electron beam generator, in addition to a step of compressing the by-products, and the addition of a coating onto same.

The present invention aims to disclose a method for marking paper, cardboard and fabric in which the post-treatment steps are avoided. The marking method that is the subject matter of the present invention is thus more efficient and economical than other known methods.

The applicant of the present invention has discovered that volatile by-products of carbonisation do not appear in a laser marking method using an ultraviolet or visible spectrum laser. Unlike the prior art, in which pre-heating is carried out to increase the printing speed of an infrared laser, in order to mark with an ultraviolet or visible spectrum laser, the method according to the present invention comprises a step of heating the area to be printed to a temperature close to the temperature at which the visual appearance of the material changes to facilitate the action of the ultraviolet or visible spectrum laser, so that said laser heats the printing area starting from a predetermined temperature that allows it to reach the temperature at which the visual appearance of the material changes. This temperature at which the visual appearance of the material changes can be, more specifically, a temperature at which the material changes colour (for example changing to black) and, especially in the case of paper and/or cardboard, a carbonisation temperature of said material.

More particularly, the present invention discloses a method for marking at least one portion of a surface of an object, said surface being made of a material that is paper or cardboard or fabric, the method comprising the following steps:
heating the surface of the material by means of a heat source to a temperature lower than the temperature at which the visual appearance of the material changes, said temperature preferably being a temperature lower than the temperature at which the material changes colour, and even more preferably a temperature lower than a carbonisation temperature of the material;
marking the heated surface by means of a marking laser, so that the light beam of the laser raises the temperature on the surface of the material enough to change the visual appearance of said surface; the laser used in marking being a laser with a light beam that belongs to the visible or ultraviolet spectrum; and said change of visual appearance being more preferably a change of colour of the material, and even more preferably a change of colour of the material to black.

The visible or ultraviolet spectrum laser is different from the laser used in other prior art documents. In these documents, the marking is carried out by an infrared laser. A visible or ultraviolet spectrum laser produces a higher-contrast marking than that achieved by an infrared laser under the same conditions.

Surprisingly, marking or printing with a laser that emits in the band of the visible or ultraviolet spectrum favours immediate polymerisation of carbonisation by-products such as tar, avoiding the appearance of said by-products, and also avoiding the need for post-treatment of the material in order to eliminate said by-products.

Therefore, since it prevents the presence of said by-products, the method according to the present invention does away with the need to perform a post-treatment on the material.

The heat source used to heat the surface of the material in the heating step is preferably an infrared laser. More preferably, the infrared laser used in the heating step is a CO₂ laser.

One advantage of marking by means of a heat source that heats the surface very locally and a visible or ultraviolet spectrum marking laser is that, since it requires less energy than other types of radiation known in the prior art, it allows printing on boxes or other objects made of paper, cardboard or fabric which are full on the inside, without damaging the component located inside of it. It also allows marking with a moving product without needing to stop the product to be printed.

However, in order to be able to reach the colour-change temperature of the material, the area to be printed is heated to a temperature close to the colour-change temperature by means of a preferably very localised heat source, so that the visible or ultraviolet spectrum laser heats said printing area starting from a predetermined temperature that makes it possible to reach said colour-change temperature, and more preferably the temperature for changing colour to black.

The marking laser preferably has a wavelength of 590 to 10 nm. More preferably, it has a wavelength of 590 to 280 nm. Even more preferably, it has a wavelength between 532 and 355 nm.

The heat source used in the heating step preferably goes along the same path over the surface of the object as the marking laser. More preferably, the marking laser acts after the heat source used in the heating step with a time difference of less than 100 ms. This configuration has the advantage that it allows the temperature raised by the heat source not to decrease significantly before the action of the marking laser, causing the temperature to be maintained in the desired range and ensuring that the temperature increase to be provided by the marking laser is low.

The method preferably does not include a step of fixing marking by-products.

The present invention also discloses a system for marking at least one portion of the surface of an object by the above method, said object being made of a material that is paper and/or cardboard and/or fabric, said system comprising two lasers that act on a surface to be marked of the material, the first of said lasers being a heating laser which is an infrared laser configured to heat the surface of the material to a temperature lower than the temperature at which the visual appearance of the material changes, more preferably the temperature at which the material changes colour, and even more preferably the carbonisation temperature of the material, and the second of these two lasers being a marking laser that is a laser with a light beam that belongs to the visible or ultraviolet spectrum, configured to raise the temperature on the surface of the object enough to change the visual appearance of said surface; the system comprising means for guiding both lasers, the guiding means being configured so that both lasers follow the same path, in order for the infrared laser to pass over said path first, followed by the marking laser.

The marking laser preferably has a wavelength of 590 to 10 nm. More preferably, it has a wavelength of 590 to 280 nm. Even more preferably, it has a wavelength between 532 and 355 nm.

The infrared laser is preferably a CO₂ laser.

The guiding means are preferably configured so that the marking laser follows the same path as the heating laser with a time difference of less than 100 ms.

The characteristics of the laser beams of the lasers (beam diameter, power, irradiance, fluence, actuation times of each beam, beam separation, travel speed, etc.) can be controlled by known control means, such as optical, electrical and electronic systems. The combination of specific action characteristics of the two combined beams achieves the desired variation of the physical and chemical characteristics of the surface, so that an optimal contrast is achieved.

The power of the first laser beam is preferably controlled so that the chosen beam diameter produces a surface power density (irradiance) that heats the material to the threshold temperature lower than the carbonisation temperature of the material, without changing the colour. Similarly, and for a given power of the marking laser beam, the speed of movement of the beam is controlled so that the exposure time of the surface heated by the first beam is that necessary for achieving the surface energy density (fluence) that causes the sought physical-chemical colour change on the surface. This colour change is such that the particles of the material change colour and are embedded in the same surface without any free particles or volatile by-products being produced that may affect the print quality.

A diagram and a drawing of one embodiment of the present invention are appended to ensure better understanding through explanatory but non-exhaustive examples.

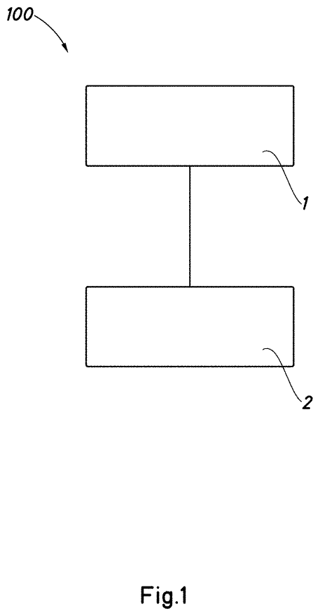

FIG. 1 shows a diagram of one embodiment of a marking method according to the present invention.

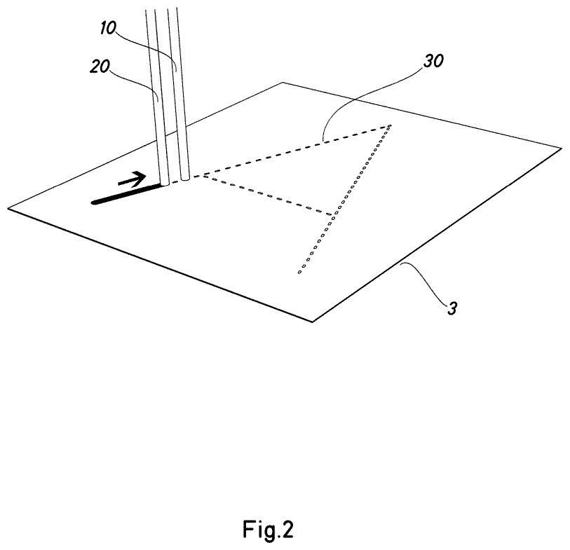

FIG. 2 shows a diagrammatic example of one embodiment of a marking method according to the present invention.

FIG. 1 shows an embodiment of a method 100 for marking an object which, in the example, is made of a material that is paper or cardboard. The marking method according to the present invention comprises two steps: a first step 1 of heating the surface of the material, and a second step 2 of marking the surface of the material.

In the heating step 1, the area or region of the surface of the material on which a certain character, logo, code, image, etc. is to be marked or printed is heated by means of a heat source, without requiring any previous treatment of the surface to be printed (without requiring the use of any type of pigment or ink).

In this step 1, the heat source raises the temperature of the material to a temperature lower than the temperature at which the visual appearance of the material changes, preferably to a temperature close to said temperature. This heating is preferably carried out gradually. In the case of cellulosic materials such as paper or cardboard, the preferred temperature for changing visual appearance is the carbonisation temperature of the material, at which the material changes colour and turns black.

The heat source used in heating step 1 is an infrared laser 10 (shown in FIG. 2), more preferably a CO₂ laser. CO₂ lasers commonly emit in an infrared wavelength band between 9.3 and 10.8 μm, this type of laser being preferable for its proven ability to heat. Alternatively, other types of heat sources can be used.

Unlike other prior art documents in which the infrared laser is used to mark or print on the surface of the material, in the embodiment of the present invention the infrared laser is only used to heat the material to a temperature lower than the carbonisation temperature of the material (without reaching it).

The heating step 1 aims to facilitate the marking that is carried out in the marking step 2, in which a laser 20 (see FIG. 2) is used to raise the surface temperature of the material beyond the colour-change temperature. Since the material does not reach the carbonisation temperature in this heating step 1, no type of marking or printing is carried out on the surface of the material in this step. Due to the heating performed in the heating step 1, the laser 20 used in the marking step 2 needs less energy to raise the temperature of the material to the carbonisation temperature, thus speeding up the marking step 2.

In addition, the temperature increases gradually, avoiding the creation of volatile by-products and optimising the permanence on the surface of the black-coloured compounds (char, tar) resulting from the process, thus optimising the print quality.

The exact carbonisation temperature depends on the type of material to be printed or marked. For paper or cardboard, the surface of the material is raised to 100-200° C., always below the carbonisation temperature of the material. The temperature to which the material is heated is achieved by modifying the laser power intensity.

In the marking step 2, the surface of the material is marked by a process of selective carbonisation of the paper or cardboard. The marking is carried out by means of a laser 20 (see FIG. 2) so that the laser beam 20 raises the temperature on the surface 30 of the material 3 enough to carbonise said surface 30, changing its colour and producing the printing on the material.

The laser 20 used in the marking step 2 is a visible or ultraviolet spectrum laser, with a wavelength preferably of 590 to 10 nm, more preferably of 590 to 280 nm, and even more preferably between 532 and 355 nm.

FIG. 2 shows a system for marking a surface 30 of a cellulosic material 3 on which characters, logos, codes, images, etc. are to be printed, by using two lasers 10, 20 and in accordance with the previous method.

Both lasers 10, 20 serve different purposes, the first laser being a heating laser 10 that locally heats the surface to be printed without changing the visual appearance of the material 3, and the second laser being a marking laser 20 that produces a carbonisation reaction on the affected surface so that the colour of the surface 30 of the material 3 changes from a light colour to a black colour, achieving a high contrast. More specifically, the heating laser 10 is an infrared laser, more preferably a CO₂ laser, while the marking laser 20 is a visible or ultraviolet spectrum laser.

The marking system of FIG. 2 also comprises means for guiding the lasers 10, 20 over the surface 30 of the material 3 to be marked. The heating laser 10 is guided over the surface of the material in such a way that it only strikes the surface 30 of the material 3 to be printed or marked, forming characters, logos, codes, images, etc. The marking laser 20 is guided in a similar fashion, and acts on the same surface of the material as the heating laser 10, without affecting the characteristics of the adjoining surface. Both lasers 10, 20 act only on the desired surface 30, without affecting the characteristics of the nearby surface that it is not to be printed.

The guiding means are configured so that the marking laser 20 passes over the same path as the heating laser 10 with a time difference of less than 100 ms, the action of both lasers 10, 20 being practically simultaneous. To achieve this effect, the diameter of the first laser beam can be adjusted to affect only the surface over which the second beam will pass.

While the invention has been described and represented based on a representative example, it should be understood that said exemplary embodiment has no limiting effect on the present invention, so any of the variations that are included directly or by way of equivalence in the content of the appended claims should be considered to be included in the scope of the present invention.

1. A method for marking at least one portion of a surface of an object, said surface being made of a material that is paper, cardboard or fabric, the method comprising the following steps:
heating the surface of the material by means of a heat source to a temperature lower than a temperature at which the visual appearance of the material changes;
marking the heated surface by means of a marking laser, so that the light beam of the laser raises the temperature on the surface of the material enough to change the visual appearance of said surface;
wherein marking laser is a laser with a light beam that belongs to the visible or ultraviolet spectrum.

2. The method according to claim 1, wherein the heat source used in the heating step is an infrared laser.

3. The method according to claim 2, wherein the infrared laser is a CO₂ laser.

4. The method according to claim 1, wherein the marking laser has a wavelength of 590 to 10 nm.

5. The method according to claim 1, wherein the marking laser has a wavelength of 590 to 280 nm.

6. The method according to claim 1, wherein the marking laser has a wavelength of 532 to 355 nm.

7. The method according to claim 1, wherein the heat source used in the heating step goes along the same path over the surface of the object as the marking laser.

8. The method according to claim 7, wherein the marking laser acts after the heat source used in the heating step with a time difference of less than 100 ms.

9. The method according to claim 1, wherein it does not include a step of fixing marking by-products.

10. A system for marking at least one portion of the surface of an object by means of the method according to claim 1, said object being made of a material that is paper, cardboard or fabric, wherein it comprises two lasers that act on a surface to be marked of the material, the first of said lasers being a heating laser configured to heat the surface of the material to a temperature lower than the temperature at which the visual appearance of the material changes, and the second of these two lasers being a marking laser that is a laser with a light beam that belongs to the visible or ultraviolet spectrum, configured to raise the temperature on the surface of the object enough to change the visual appearance of said surface; the system comprising means for guiding both lasers, the guiding means being configured so that both lasers follow the same path, in order for the heating laser to pass over said path first, followed by the marking laser.

11. The system according to claim 10, wherein the marking laser has a wavelength of 590 to 10 nm.

12. The system according to claim 10, wherein the marking laser has a wavelength of 590 to 280 nm.

13. The system according to claim 10, wherein the marking laser has a wavelength between 532 and 355 nm.

14. The system according to claim 16, wherein the infrared laser is a CO₂ laser.

15. The system according to claim 10, wherein the guiding means are configured so that the marking laser follows the same path as the heating laser with a time difference of less than 100 ms.

16. The system according to claim 10, wherein the heating laser is an infrared laser.
